(19) United States
(12) Patent Application Publication
(10) Pub. No.: US 2018/0004660 A1
(43) Pub. Date: Jan. 4, 2018

(54) DIRECT STORE TO COHERENCE POINT

(71) Applicant: Microsoft Technology Licensing, LLC, Redmond, WA (US)

(72) Inventors: Patrick P. Lai, Fremont, CA (US); Robert Allen Shearer, Woodinville, WA (US)

(21) Appl. No.: 15/199,699

(22) Filed: Jun. 30, 2016

(51) Int. Cl. G06F 12/0806

(52) U.S. Cl. CPC G06F 12/0806; G06F 2212/452; G06F 2212/6042

(57) ABSTRACT

A system that uses a write-invalidate protocol has at least two types of stores. A first type of store operation uses a write-back policy resulting in snoops for copies of the cache line at lower cache levels. A second type of store operation writes, using a coherent write-through policy, directly to the last-level cache without snooping the lower cache levels. By storing directly to the coherence point, where cache coherence is enforced, for the coherent write-through operations, snoop transactions and responses are not exchanged with the other caches. A memory order buffer at the last-level cache ensures proper ordering of stores/loads sent directly to the last-level cache.

### BACKGROUND

Integrated circuits, and systems-on-a-chip (SoC) may include two or more independent processing units (a.k.a., “cores”) that read and execute instructions. These multi-core processing chips may cooperate to implement multiprocessing. The designers of these chips may select various techniques to couple the cores in a device so that they may share instructions and/or data.

### SUMMARY

Examples discussed herein relate to an integrated circuit that includes a plurality of processor cores that share a common last-level cache. The plurality of processor cores including at least a first processor core. The integrated circuit also includes a memory order buffer. The memory order buffer is to receive store transactions sent to the last-level cache. These store transactions include first transactions that are indicated by the first processor core to be written directly to the common last-level cache. The store transactions also include second transactions that are indicated by the first processor core to be processed by a lower-level cache before being sent to the last-level cache.

In an example, a method of operating a processing system includes receiving, from a plurality of processor cores, a plurality of store transactions at a common last-level cache. The plurality of processor cores including a first processor core. The method also includes issuing, by the first processor core and to the common-last level cache, at least a first store transaction and a second store transaction. The first store transaction is indicated to be written directly to the common last-level cache. The second store transaction is indicated to be processed by a lower-level cache before being sent to the last-level cache. The method also includes receiving, at a memory order buffer, the first store transaction and data stored by the second store transaction.

In an example, a processing system includes a plurality of processing cores each coupled to at least a first level cache. The processing system also includes a last-level cache that is separate from the first level cache. The last-level cache receives store data from the first level cache and the plurality of processing cores. The processing system also includes a memory order buffer, coupled to the last-level cache, that receives a first line of store data from the first level cache. The memory order buffer also receives a second line of store data from a first processing core of the plurality of processing cores without the second line of store data being processed by the first level cache.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1A is a block diagram illustrating a processing system.

FIG. 1B is a diagram illustrating the flow of data to a last-level cache.

FIG. 1C is a diagram illustrating transactions associated with the flow of data to the last-level cache.

FIG. 2 is a flowchart of a method of operating a processing system.

FIG. 3 is a diagram illustrating a last-level cache pipeline coupled to multiple processors.

FIG. 4 is a block diagram of a computer system.

### DETAILED DESCRIPTION OF THE EMBODIMENTS

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may include a machine-implemented method and/or a computing device.

In a system that uses a write-invalidate protocol, writes to a line that resides in the last-level cache (e.g., the level 3 cache in a system with three levels of cache) invalidates other copies of that cache line at the other cache levels. For example, a write to a line residing in the level 3 (L3) cache invalidates other copies of that cache line that are residing in the L1 and/or L2 caches of the cores and/or core clusters (aside from the copy already on a cache within the requesting core). This makes stores to cache lines that are shared with lower cache levels both time consuming and resource expensive since messages need to be sent to (e.g., snoop transactions), and received from (e.g., snoop responses), each of the caches at each of the cache levels.

In an embodiment, there are two types of stores: a traditional store that operates using a write-back policy that snoops for copies of the cache line at lower cache levels, and a store that writes, using a coherent write-through policy, directly to the last-level cache without snooping the lower cache levels. For the coherent write-through operations, snoop transactions and responses are not exchanged with the other caches—thereby saving the time and resources associated with snooping for shared copies of the cache line being written. A memory order buffer at the last-level cache ensures the proper ordering of stores (and also loads) before they are committed to memory. It should be understood that the memory order buffer described herein resides at the last level cache. This is in contrast to a memory order buffer (a.k.a. as a load or store buffer) that reside within a processor pipeline on the path to the L1 cache.

As used herein, the term “processor” includes digital logic that executes operational instructions to perform a sequence of tasks. The instructions can be stored in firmware or software, and can represent anywhere from a very limited to a very general instruction set. A processor can be one of several “cores” that are collocated on a common die or integrated circuit (IC) with other processors. In a multiple processor (“multi-processor”) system, individual processors can be the same as or different than other processors, with potentially different performance characteristics (e.g., operating speed, heat dissipation, cache sizes, pin assignments, functional capabilities, and so forth). A set of “asymmetric” processors refers to a set of two or more processors, where at least two processors in the set have different performance capabilities (or benchmark data). As used in the claims below, and in the other parts of this disclosure, the terms “processor” and “processor core” will generally be used interchangeably

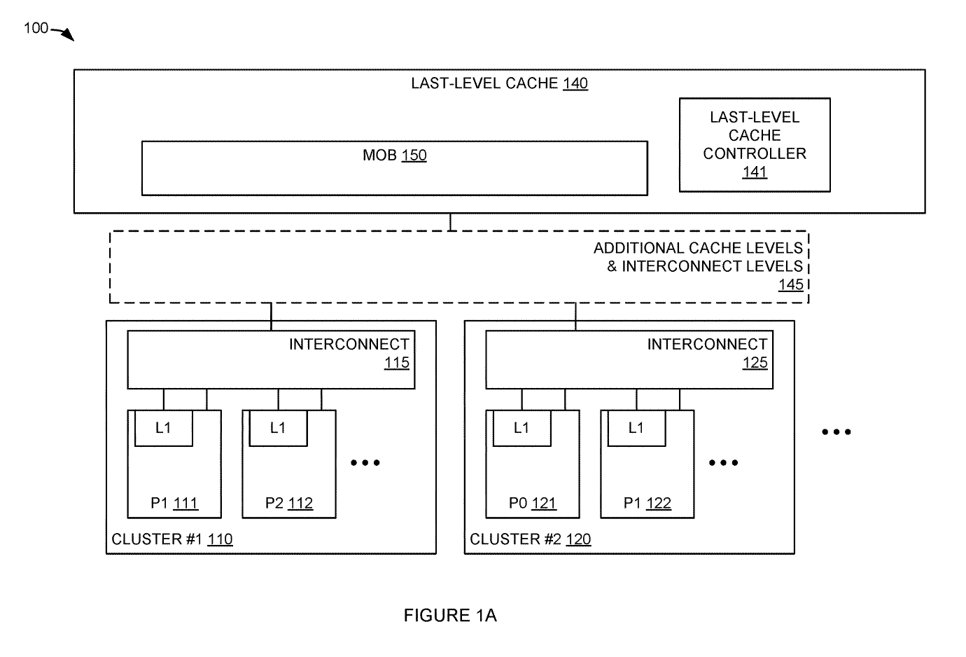

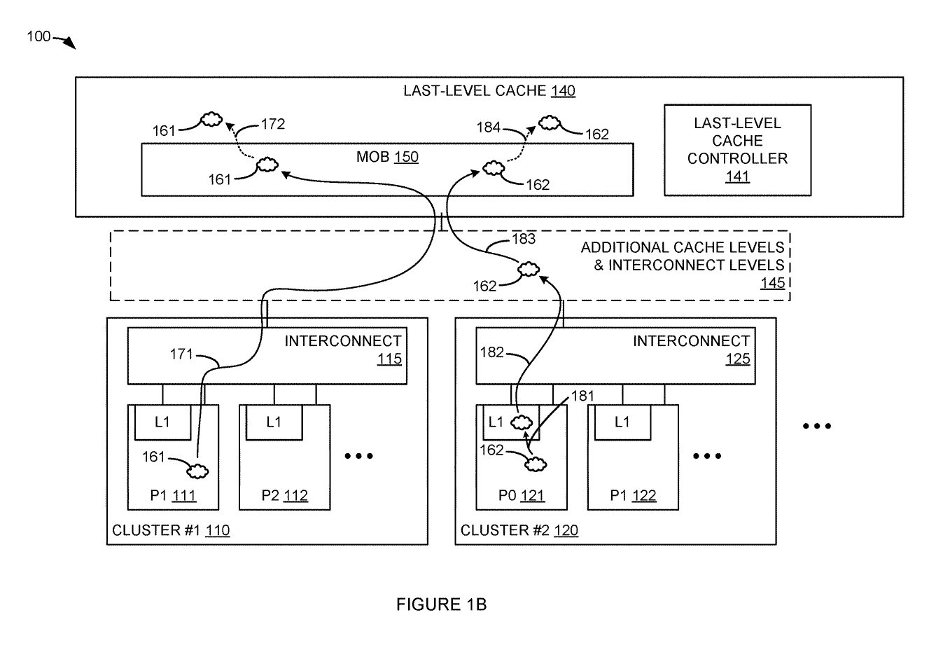

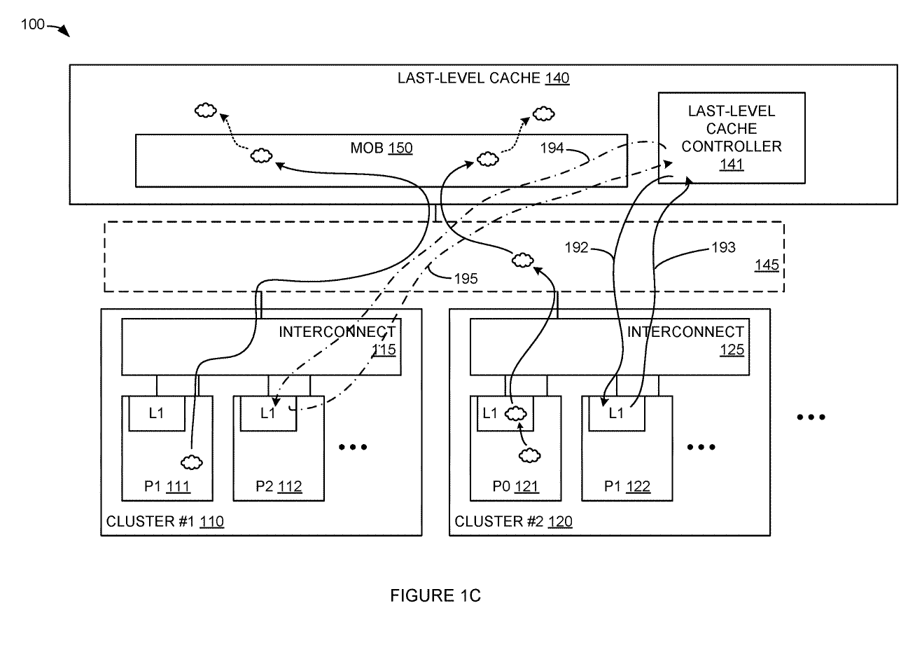

FIG. 1A is a block diagram illustrating a processing system. In FIG. 1, processing system 100 includes processing cluster 110, processing cluster 120, additional cache levels and/or interconnect levels (cache/interconnect) 145, and last-level cache 140. Processing cluster #1 110 includes processor P1 111, processor P2 112, and interconnect 115. Processing cluster 110 may include additional processors (not shown in FIG. 1). Processing cluster #2 120 includes processor P1 121, processor P2 121, and interconnect 125. Processing cluster 120 may include additional processors (not shown in FIG. 1). Each of processors 111, 112, 121, and 122 include (at least) level 1 (L1) caches. Last-level cache 140 includes last-level cache controller 141 and memory order buffer (MOB) 150. Processing system 100 may include additional processing clusters comprised of additional processors and cache(s) (not shown in FIG. 1.)

Processor 111 is operatively coupled to interconnect 115 of cluster 110. Processor 111 is operatively coupled to interconnect 115 of cluster 110. The L1 cache of processor 111 is also operatively coupled to interconnect 115. Processor 112 is operatively coupled to interconnect 115. The L1 cache of processor 112 is also operatively coupled to interconnect 115. Additional processors in cluster 110 (not shown in FIG. 1) may also be operatively coupled to interconnect 115 of cluster 110.

Processor 121 is operatively coupled to interconnect 125 of cluster 120. Processor 121 is operatively coupled to interconnect 125 of cluster 120. The L1 cache of processor 121 is also operatively coupled to interconnect 125. Processor 122 is operatively coupled to interconnect 125. The L1 cache of processor 122 is also operatively coupled to interconnect 125. Additional processors in cluster 120 (not shown in FIG. 1) may also be operatively coupled to interconnect 125 of cluster 120.

Cache/interconnect 145 is operatively coupled to cluster 110 via interconnect 115. Cache/interconnect 145 is operatively coupled to cluster 120 via interconnect 125. Cache/interconnect 145 is operatively coupled to last-level cache 140. Thus, the data associated with memory operations (e.g., loads, stores, etc.) originating from processor 111 and processor 112 may be exchanged with last-level cache 140, and memory order buffer 150 in particular, via interconnect 115 and cache/interconnect 145. Likewise, the data associated with memory operations originating from processor 121 and processor 122 may be exchanged with last-level cache 140, and memory order buffer 150 in particular, via interconnect 125 and cache/interconnect 145. Therefore, it should be understood that cluster 110 and cluster 120 (and thus processors 111, 112, 121, and 122) share last-level cache 140.

In an embodiment, MOB 150 receives store transactions from processors 111, 112, 121, and 122. Some of these store transactions may be indicated (e.g., by the contents of the transaction itself, or some other technique) to be written directly to last-level cache 140. In this case, processing system 100 (and last-level cache 140, in particular) does not query (i.e., ‘snoop’) the lower level caches (e.g., the L1 caches of any of processors 111, 112, 121, or 122) to determine whether any of these lower level caches has a copy of the affected cache line.

Other of these store transactions may be indicated to be processed by lower-level caches. In this case, processing system 100 (and last-level cache 140, in particular) queries the lower level caches of processors 111, 112, 121, and 122, and the caches (if any) of cache/interconnect 145.

In an embodiment, the store transactions may be indicated to be written directly to last-level cache 140 based on the type of store instruction that is being executed. In other words, the program running on a processor 111, 112, 121, or 122 may elect to have a particular store operation go directly to last-level cache 140 by using a first type of store instruction that indicates the store data is to go directly to cache 140. Likewise, the program running on a processor 111, 112, 121, or 122 may elect to have a particular store operation be processed (e.g., be cached) by lower level caches by using a second type of store instruction that indicates the store data may be processed by the lower level caches.

In an embodiment, the store transactions may be indicated to be written directly to last-level cache 140 based on the addresses targeted by these store transactions being within a configured addressed range. In other words, store operations that are addressed to a configured address range may be sent by processing system 100 directly to last-level cache 140. Likewise, store operations that are addressed to a different address range may be processed by the lower level caches. One or both of these address ranges may be configured, for example, by values stored in memory and/or registers in processing system 100 (and processors 111, 112, 121, and 122, in particular.) These registers and/or memory may be writable by one or more of processors 111, 112, 121, and 122.

In an embodiment, the address ranges that determine whether a store operation will be sent directly to last-level cache 140 can correspond to one or more physical or virtual memory pages. In this case, a page-table entry may store one or more indicators that determine whether stores directed to the corresponding memory page are to be sent directly to last-level cache 140.

Thus, it should be understood that processing system 100 implements a way of storing data into cache memory that can be used for frequently shared data. For the frequently shared data, the store operation associated with this data is indicated to be stored through direct to the coherence point (which is located at last-level cache 140.) This technique helps significantly reducing snoops caused by subsequent readers of the cache line. This technique also allows store-to-load forwarding by MOB 150 since all cache line access to the relevant physical address are mapped to the same coherence point on systems that distribute physical address space among multiple last-level cache 150 slices. It should be understood that the coherence point in a memory hierarchy where cache coherence is enforced. In processing system 100, the cache coherence point is at the last-level cache.

MOB 150, which resides at last-level cache 150 slices performs store-to-load forwarding. MOB 150 may also enforce write ordering in a manner consistent with the Instruction Set Architecture (ISA) of one or more of processors 111, 112, 121, and 122.

In an embodiment, a processor 111, 112, 121, or 122 may directly (as described herein) send a speculative store operation to last-level cache 140 along with the data for that store. Once this store operation arrives at last-level cache 140, and last-level cache 140 determines the line is in a shared state (e.g., “S” of a system implementing MOESI cache line states), last-level cache 140 stores this line without further snoops or other related transactions (e.g., snoop responses) to/from other caches. Last-level cache 140 then updates the line to a modified (e.g., “M”) state in last-level cache 140. Last-level cache 140 also sends transactions that invalidate all the other copies in the lower level caches. Alternatively, last-level cache 140 may send transactions that set the line to an owned (e.g., “O”) state. Last-level cache 140 sends a response of “Set Requester Line to M” back to the requesting processor 111, 112, 121, 122 that indicates a success. A store buffer within the requesting processor 111, 112, 121, 122 can then retire the store operation and have the store committed.

It is worth noting that this process saves at the least the round trip time for the store operation to be issued from the processor 111, 112, 121, 122 store buffer to the last-level cache 140, and for the snoops to be sent to the caches in processing system 100. During this whole round trip time, the requesting processor 111, 112, 121, 122 keeps the store operation as an outstanding store. Also during this round trip time, the requesting processor 111, 112, 121, 122 operates as if the store has not been completed. This allows a requesting processor 111, 112, 121, 122 to roll back the store operations in case the store-forwarding information in MOB 150 of last-level cache 140 is wrong.

FIG. 1B is a diagram illustrating the flow of data to a last-level cache. In FIG. 1B, processing system 100 is illustrated with store data 161 and store data 162. Store data 161 is sent directly to MOB 150. This is illustrated by arrow 171 flowing from processor 111, through interconnect 115, through cache/interconnect 145 (but not any caches in cache/interconnect 145), to MOB 150. After arriving at MOB 150, data 161 is stored in last-level cache 150. This is illustrated by arrow 172 flowing from MOB 150 to the main portion of last-level cache 140.

Store data 162 is processed by lower level caches before being sent to last-level cache 150. This is illustrated by arrow 181 flowing from processor 121 to the L1 cache of processor 121. From the L1 cache of processor 121, data 162 is then sent to cache/interconnect 145. This is illustrated by arrow 182 flowing from the L1 cache of processor 121 through interconnect 125 to cache/interconnect 145. From cache/interconnect 145, data 162 is sent to MOB 150. This is illustrated by arrow 183 flowing from cache/interconnect 145 to MOB 150. After arriving at MOB 150, data 162 is stored in last-level cache 150. This is illustrated by arrow 184 flowing from MOB 150 to the main portion of last-level cache 140.

FIG. 1C is a diagram illustrating transactions associated with the flow of data to the last-level cache. In FIG. 1C, processing system 100 is illustrated with first store data (e.g., store data 161) flowing directly from processor 111 to MOB 150 and second store data (e.g., store data 162) flowing from processor 121 to MOB after being processed by lower level caches (e.g., L1 of processor 121 and the caches, if any, of cache/interconnect 145). FIG. 1C also illustrates, using arrows 192-196, snoop query and snoop response transactions. Arrow 192, which represents a snoop query transaction, flows from the cache controller 141 of last-level cache 140 to the L1 cache of processor 122. Arrow 193, which represents the snoop response transaction, flows from the L1 cache of processor 122 to the cache controller 141 of last-level cache 140. Arrow 194, which represents a snoop query transaction, flows from the cache controller 141 of last-level cache 140 to the L1 cache of processor 112 in cluster 110. Arrow 195, which represents the snoop response transaction, flows from the L1 cache of processor 112 to the cache controller 141 of last-level cache 140.

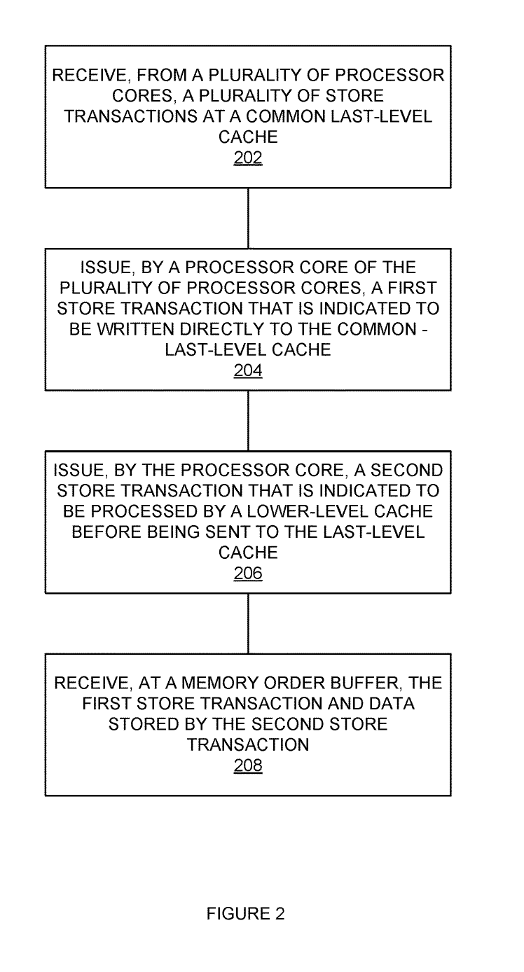

FIG. 2 is a flowchart of a method of operating a processing system. The steps illustrated in FIG. 2 may be performed by one or more elements of processing system 100. From a plurality of processor cores, a plurality of store transactions are received at a common last-level cache (202). For example, last-level cache may receive store transactions from processors 111, 112, 121, and 122.

By a processor core of the plurality of processor cores, a first store transaction is issued that is indicated to be written directly to the common last-level cache (204). For example, processor 111 may issue a store transaction. This store transaction may be indicated to be written directly to last-level cache 140. This store transaction may be, for example, indicated to be written directly to last-level cache 140 based on the type of store instruction executed by processor 111. In another example, this store transaction may be indicated to be written directly to last-level cache 140 based on the addresses targeted by the store transactions being within a configured addressed range. The address range(s) may be configured, for example, by values stored in memory and/or registers in processing system 100 (and processor 111, in particular.) These registers and/or memory may be writable by processor 111. In another example, the address range(s) that determine whether this store operation will be sent directly to last-level cache 140 can correspond to one or more physical or virtual memory pages. For example, a page-table entry may store one or more indicators that determine whether or not store operations directed to the corresponding memory page are to be sent directly to last-level cache 140.

By the processor core, a second store transaction is issued that is indicated to be processed by a lower-level cache before being sent to the last-level cache (206). For example, processor 111 may issue a store transaction that is to be processed by the L1 cache of processor 111 and any intervening caches in cache/interconnect 145. This store transaction may be, for example, indicated to be processed (e.g., be cached) by lower level caches based on the type of store instruction executed by processor 111. In another example, this store transaction may be indicated to be processed by the lower level caches based on the addresses targeted by the store transactions being within a configured addressed range. The address range(s) may be configured, for example, by values stored in memory and/or registers in processing system 100 (and processor 111, in particular.) These registers and/or memory may be writable by processor 111. In another example, the address range(s) that determine whether this store operation will be processed by lower level caches can correspond to one or more physical or virtual memory pages. For example, a page-table entry may store one or more indicators that determine whether or not store operations directed to the corresponding memory page are to be processed by lower level caches.

At a memory order buffer, the first store transaction and data stored by the second store transaction are received (208). For example, MOB 150 may receive the first store transaction directly from processor 111. MOB 150 may also receive data that has been processed by lower cache levels. MOB 150 may receive the data that has been processed by lower cache levels when the cache line associated with the data is, for example, written by another processor 112, 121, or 122.

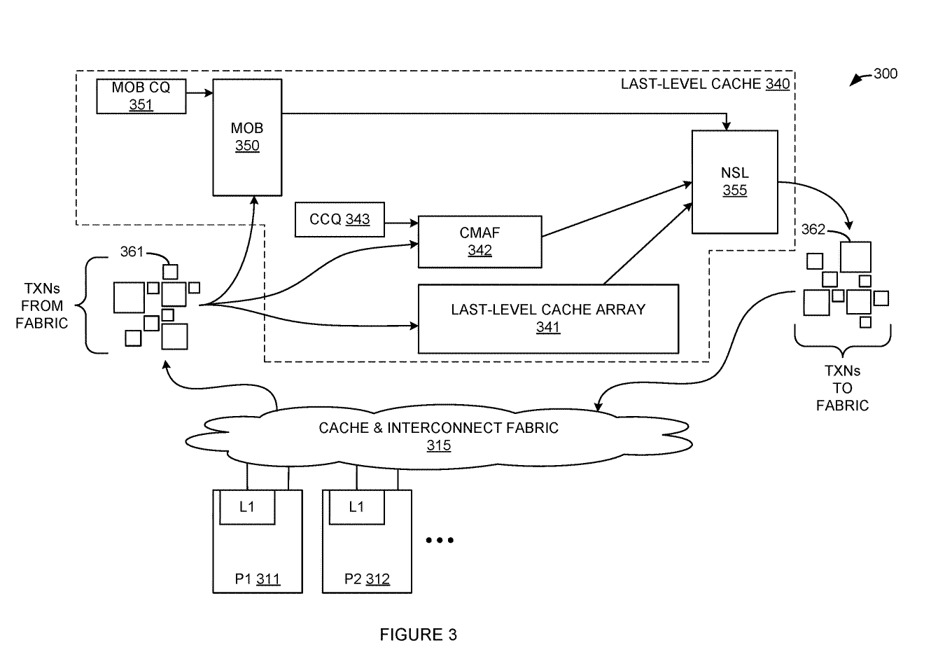

FIG. 3 is a diagram illustrating a last-level cache pipeline coupled to multiple processors. In FIG. 3, processing system 300 comprises processor 311, processor 312, cache and interconnect fabric 315, and last-level cache 340. Last-level cache 340 includes memory order buffer (MOB) 350, memory order buffer conflict queue (MOB CQ) 351, last-level cache array 341, cache miss address file (CMAF) 342, cache conflict queue (CCQ) 343, and next state logic (NSL) 355. Processor 311 includes a lower level cache L1. Processor 312 includes a lower level cache L1. Also illustrated in FIG. 3 are transactions 361 and transactions 362.

Processor 311 and processor 312 are operatively coupled to fabric 315. Fabric 315 provides transactions 361 to last-level cache 340. Last-level cache 340 provides transactions 362 to fabric 315. Fabric 315 may send transactions 362 (e.g., one or more transactions containing read data) to one or more of processors 311 and 312.

Transactions 361 originate from one or more of processors 311 and 312. Transactions 361 may include store transactions that are sent directly from a processor 311 or 312 to last-level cache 340 without being processed by lower level caches (e.g., the L1 cache of processor 311 or the cache levels of fabric 315, if any). Transactions 361 may include store transactions that are sent from a lower level cache (e.g., the L1 cache of processor 311 or the cache levels of fabric 315, if any). Transactions 361 may include load transactions that are directed to access data recently sent to last-level cache 340.

Transactions 361 are distributed by last-level cache 340 to MOB 350, CMAF 342, and cache array 341. MOB 350 holds store transactions 361 until these store transactions are written to last-level cache array 341. A load transaction 361 that corresponds to a store transaction in MOB 350 causes MOB 350 to provide the data from the store transaction directly to next state logic 355—thereby bypassing CMAF 342 and cache array 341. NSL 355 outputs transactions 362 to fabric 315. Thus, it should be understood that last-level cache 340 may implement store-to-load forwarding. The forwarded data may include data that was sent directly from a processor 311 or 312 to last-level cache 340 without being processed by lower level caches. The forwarded data may include data that was sent to last-level cache 340 after being stored in one or more lower level caches (e.g., the L1 cache of processor 311 or the cache levels of fabric 315, if any).

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of processing system 100, and/or processing system 300, and their components. These software descriptions may be: behavioral, register transfer, logic component, transistor, and layout geometry-level descriptions.

Data formats in which such descriptions may be implemented are stored on a non-transitory computer readable medium include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Physical files may be implemented on non-transitory machine-readable media such as: 4 mm magnetic tape, 8 mm magnetic tape, 3½-inch floppy media, CDs, DVDs, hard disk drives, solid-state disk drives, solid-state memory, flash drives, and so on.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), multi-core processors, graphics processing units (GPUs), etc.

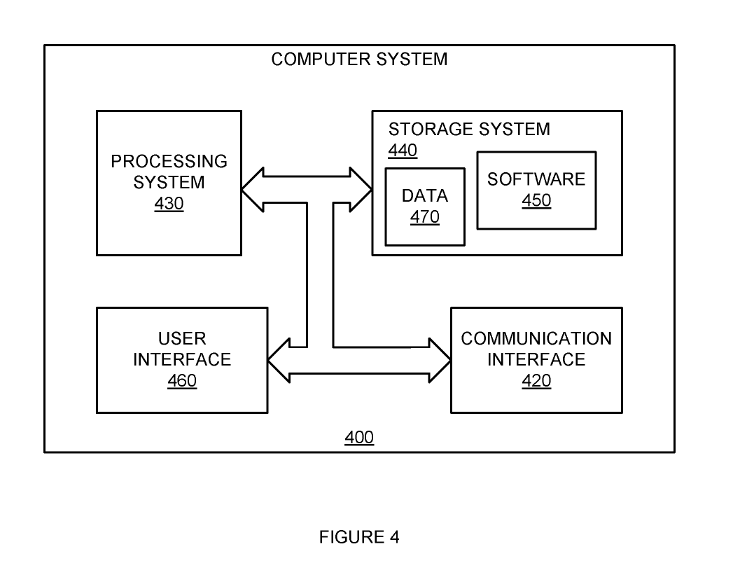

FIG. 4 illustrates a block diagram of an example computer system. Computer system 400 includes communication interface 420, processing system 430, storage system 440, and user interface 460. Processing system 430 is operatively coupled to storage system 440. Storage system 440 stores software 450 and data 470. Processing system 430 is operatively coupled to communication interface 420 and user interface 460. Processing system 430 may be an example of one or more of processing system 100, processing system 300, and/or their components.

Computer system 400 may comprise a programmed general-purpose computer. Computer system 400 may include a microprocessor. Computer system 400 may comprise programmable or special purpose circuitry. Computer system 400 may be distributed among multiple devices, processors, storage, and/or interfaces that together comprise elements 420-470.

Communication interface 420 may comprise a network interface, modem, port, bus, link, transceiver, or other communication device. Communication interface 420 may be distributed among multiple communication devices. Processing system 430 may comprise a microprocessor, microcontroller, logic circuit, or other processing device. Processing system 430 may be distributed among multiple processing devices. User interface 460 may comprise a keyboard, mouse, voice recognition interface, microphone and speakers, graphical display, touch screen, or other type of user interface device. User interface 460 may be distributed among multiple interface devices. Storage system 440 may comprise a disk, tape, integrated circuit, RAM, ROM, EEPROM, flash memory, network storage, server, or other memory function. Storage system 440 may include computer readable medium. Storage system 440 may be distributed among multiple memory devices.

Processing system 430 retrieves and executes software 450 from storage system 440. Processing system 430 may retrieve and store data 470. Processing system 430 may also retrieve and store data via communication interface 420. Processing system 450 may create or modify software 450 or data 470 to achieve a tangible result. Processing system may control communication interface 420 or user interface 460 to achieve a tangible result. Processing system 430 may retrieve and execute remotely stored software via communication interface 420.

Software 450 and remotely stored software may comprise an operating system, utilities, drivers, networking software, and other software typically executed by a computer system. Software 450 may comprise an application program, applet, firmware, or other form of machine-readable processing instructions typically executed by a computer system. When executed by processing system 430, software 450 or remotely stored software may direct computer system 400 to operate as described herein.

Implementations discussed herein include, but are not limited to, the following examples:

### Example 1

An integrated circuit, comprising: a plurality of processor cores that share a common last-level cache, the plurality of processor cores including at least a first processor core; and, a memory order buffer to receive store transactions sent to the last-level cache, the store transactions to include first transactions that are indicated by the first processor core to be written directly to the common last-level cache, the store transactions to include second transactions that are indicated by the first processor core to be processed by a lower-level cache before being sent to the last-level cache.

### Example 2

The integrated circuit of example 1, wherein the first transactions are indicated to be written directly to the common last-level cache based on a first type of store instruction being executed by the first processor core.

### Example 3

The integrated circuit of example 2, wherein the second transactions are indicated by the first processor core to be processed by a lower-level cache before being sent to the last-level cache based on a second type of store instruction being executed by the first processor core.

### Example 4

The integrated circuit of example 1, wherein the first transactions are to be written directly to the common last-level cache based on addresses targeted by the first transactions being within a configured address range.

### Example 5

The integrated circuit of example 1, wherein the second transactions are to be processed by a lower-level cache before being sent to the last-level cache based on addresses targeted by the second transactions being within a configured address range.

### Example 6

The integrated circuit of example 4, wherein the configured address range corresponds to at least one memory page.

### Example 7

The integrated circuit of example 5, wherein the configured address range corresponds to at least one memory page.

### Example 8

The integrated circuit of example 1, wherein the first transactions are to be written directly to the common last-level cache based on addresses targeted by the first transactions being within an address range specified by at least one register that is writable by the first processor core.

### Example 9

A method of operating a processing system, comprising: receiving, from a plurality of processor cores, a plurality of store transactions at a common last-level cache, the plurality of processor cores including a first processor core; issuing, by the first processor core and to the common-last level cache, at least a first store transaction and a second store transaction, the first store transaction to be indicated to be written directly to the common last-level cache, the second store transaction to be indicated to be processed by a lower-level cache before being sent to the last-level cache; and, receiving, at a memory order buffer, the first store transaction and data stored by the second store transaction.

### Example 10

The method of example 9, wherein the first processor core issues the first store transaction based on the execution of a first type of store instruction that is associated with writing data directly to the common last-level cache.

### Example 11

The method of example 10, wherein the first processor core issues the second store transaction based on the execution of a second type of store instruction that is associated with writing data to the lower-level cache.

### Example 12

The method of example 9, wherein the first processor core issues the first store transaction based on an address corresponding to the target of a store instruction being executed by the first processor core falling within a configured address range.

### Example 13

The method of example 9, wherein the first processor core issues the second store transaction based on an address corresponding to the target of a store instruction being executed by the first processor core falling within a configured address range.

### Example 14

The method of example 12, wherein the configured address range corresponds to at least one memory page.

### Example 15

The method of example 14, wherein a page table entry associated with the at least one memory page includes an indicator that the first processor core is to issue the first store transaction.

### Example 16

The method of example 9, further comprising: receiving, from a register written by a one of the plurality of processors, an indicator that corresponds to at least one limit of the configured address range.

### Example 17

A processing system, comprising: a plurality of processing cores each coupled to at least a first level cache; a last-level cache, separate from the first level cache, to receive store data from the first level cache and the plurality of processing cores; and, a memory order buffer, coupled to the last-level cache, to receive a first line of store data from the first level cache and to receive a second line of store data from a first processing core of the plurality of processing cores without the second line of store data being processed by the first level cache.

### Example 18

The processing system of example 17, wherein a type of instruction being executed by the first processing core determines whether the second line of store data is to be sent to the last-level cache without being processed by the first level cache.

### Example 19

The processing system of example 17, wherein an address range determines whether the second line of store data is to be sent to the last-level cache without being processed by the first level cache.

### Example 20

The processing system of example 17, wherein an indicator in a page table entry determines whether the second line of store data is to be sent to the last-level cache without being processed by the first level cache.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An integrated circuit, comprising:
a plurality of processor cores that share a common last-level cache, the plurality of processor cores including at least a first processor core; and,
a memory order buffer to receive store transactions sent to the last-level cache, the store transactions to include first transactions that are indicated by the first processor core to be written directly to the common last-level cache, the store transactions to include second transactions that are indicated by the first processor core to be processed by a lower-level cache before being sent to the last-level cache.

2. The integrated circuit of claim 1, wherein the first transactions are indicated to be written directly to the common last-level cache based on a first type of store instruction being executed by the first processor core.

3. The integrated circuit of claim 2, wherein the second transactions are indicated by the first processor core to be processed by a lower-level cache before being sent to the last-level cache based on a second type of store instruction being executed by the first processor core.

4. The integrated circuit of claim 1, wherein the first transactions are to be written directly to the common last-level cache based on addresses targeted by the first transactions being within a configured address range.

5. The integrated circuit of claim 1, wherein the second transactions are to be processed by a lower-level cache before being sent to the last-level cache based on addresses targeted by the second transactions being within a configured address range.

6. The integrated circuit of claim 4, wherein the configured address range corresponds to at least one memory page.

7. The integrated circuit of claim 5, wherein the configured address range corresponds to at least one memory page.

8. The integrated circuit of claim 1, wherein the first transactions are to be written directly to the common last-level cache based on addresses targeted by the first transactions being within an address range specified by at least one register that is writable by the first processor core.

9. A method of operating a processing system, comprising:
receiving, from a plurality of processor cores, a plurality of store transactions at a common last-level cache, the plurality of processor cores including a first processor core;
issuing, by the first processor core and to the common-last level cache, at least a first store transaction and a second store transaction, the first store transaction to be indicated to be written directly to the common last-level cache, the second store transaction to be indicated to be processed by a lower-level cache before being sent to the last-level cache; and,
receiving, at a memory order buffer, the first store transaction and data stored by the second store transaction.

10. The method of claim 9, wherein the first processor core issues the first store transaction based on the execution of a first type of store instruction that is associated with writing data directly to the common last-level cache.

11. The method of claim 10, wherein the first processor core issues the second store transaction based on the execution of a second type of store instruction that is associated with writing data to the lower-level cache.

12. The method of claim 9, wherein the first processor core issues the first store transaction based on an address corresponding to the target of a store instruction being executed by the first processor core falling within a configured address range.

13. The method of claim 9, wherein the first processor core issues the second store transaction based on an address corresponding to the target of a store instruction being executed by the first processor core falling within a configured address range.

14. The method of claim 12, wherein the configured address range corresponds to at least one memory page.

15. The method of claim 14, wherein a page table entry associated with the at least one memory page includes an indicator that the first processor core is to issue the first store transaction.

16. The method of claim 9, further comprising:
receiving, from a register written by a one of the plurality of processors, an indicator that corresponds to at least one limit of the configured address range.

17. A processing system, comprising:
a plurality of processing cores each coupled to at least a first level cache;
a last-level cache, separate from the first level cache, to receive store data from the first level cache and the plurality of processing cores; and,
a memory order buffer, coupled to the last-level cache, to receive a first line of store data from the first level cache and to receive a second line of store data from a first processing core of the plurality of processing cores without the second line of store data being processed by the first level cache.

18. The processing system of claim 17, wherein a type of instruction being executed by the first processing core determines whether the second line of store data is to be sent to the last-level cache without being processed by the first level cache.

19. The processing system of claim 17, wherein an address range determines whether the second line of store data is to be sent to the last-level cache without being processed by the first level cache.

20. The processing system of claim 17, wherein an indicator in a page table entry determines whether the second line of store data is to be sent to the last-level cache without being processed by the first level cache.
